(19) United States
(12) Patent Application Publication
(10) Pub. No.: US 2014/0109650 A1
(43) Pub. Date: Apr. 24, 2014

(54) DISSOLVED GAS CONTENT MEASUREMENT APPARATUS AND LIQUID TREATMENT APPARATUS

(71) Applicant: SEIKO EPSON CORPORATION, Tokyo (JP)

(72) Inventors: Atsushi OSHIMA, Aichi-ken (JP); Atsuya HIRABAYASHI, Chino-shi (JP)

(73) Assignee: SEIKO EPSON CORPORATION, Tokyo (JP)

(21) Appl. No.: 14/057,566

(22) Filed: Oct. 18, 2013

(30) Foreign Application Priority Data
Oct. 22, 2012 (JP) 2012-232466
Mar. 13, 2013 (JP) 2013-050264

(51) Int. Cl. G01N 19/00; G01N 27/00; G01N 27/06

(52) U.S. Cl. CPC G01N 19/00; G01N 27/06; G01N 27/00
USPC 73/37; 324/71.1

(57) ABSTRACT

A dissolved gas content measurement apparatus, which measures dissolved gas content in a liquid, includes: a flow path which includes a flow path resistance; a liquid containing chamber which communicates with the flow path; a pressure changing unit which changes inner pressure of the liquid containing chamber; a measurement unit which measures a pressure vibration cycle of the liquid, which is caused when the pressure changing unit operates, in a state where the liquid is contained in the flow path and the liquid containing chamber; and an obtaining unit which obtains the dissolved gas content based on the cycle.

This application claims priority to Japanese Patent Application Nos. 2012-232466 filed on Oct. 22, 2012 and 2013-050264 filed on Mar. 13, 2013. The entire disclosures of the Japanese Patent Application Nos. 2012-232466 and 2013-050264 are hereby incorporated herein by reference.

### BACKGROUND

1. Technical Field

The present invention relates to a technique for measuring dissolved gas content in a liquid and a compression rate.

2. Related Art

In the related art, a technique disclosed in JP-A-7-243743, for example, has been known as a technique for obtaining physical property information of a liquid as a measurement target. JP-A-7-243743 discloses a technique for estimating water content and oxygen content in a liquid as a measurement target based on water content and oxygen content in a gas phase which is generated by gasifying the liquid as a measurement target (organic solvent in JP-A-7-243743).

However, in the technique of JP-A-7-243743, the water content and the oxygen content cannot be measured in principle if the gas phase is not generated by gasifying the liquid as a measurement target, and a problem that targets and environments suitable for the measurement are limited has been pointed out. In addition, a problem that the size of a measurement system increases as a whole has been also pointed out. Moreover, it has been desired to reduce costs, save resources, facilitate manufacturing, and enhance usability, for example, in a case of measuring dissolved gas content.

### SUMMARY

An advantage of some aspects of the invention is to solve at least a part of the problems described above, and the invention can be implemented as the following forms or application examples.

(1) An aspect of the invention provides a dissolved gas content measurement apparatus which measures dissolved gas content in a liquid. The dissolved gas content measurement apparatus may include: a flow path which has a flow path resistance; a liquid containing chamber which communicates with the flow path; a pressure changing unit which changes inner pressure of the liquid containing chamber; a measurement unit which measures a pressure vibration cycle of the liquid, which is caused when the pressure changing unit operates, in a state where the liquid is contained in the flow path and the liquid containing chamber; and an obtaining unit which obtains the dissolved gas content based on the cycle. According to the dissolved gas content measurement apparatus, it is possible to directly perform measurement without changing liquid into another state (gas, for example). Therefore, it is possible to alleviate restrictions relating to measurement targets and measurement environments. In addition, since the pressure vibration cycle of the liquid is measured by the dissolved gas content measurement apparatus, it is possible to relatively easily perform the measurement. In addition, the cycle may be obtained by measuring pressure variation in a ¼ cycle or a ½ cycle of the pressure vibration and estimating a waveform of the following pressure vibration based on the measurement result.

(2) In the dissolved gas content measurement apparatus according to the above aspect, the measurement unit may measure the cycle by using a time interval, at which pressure of the pressure vibration in the liquid reaches a predetermined value. For example, the measurement unit may measure, as the pressure vibration cycle, any one of a time interval between time, at which a second wave reaches a predetermined value, and time, at which a third wave reaches a predetermined value, and a time interval between time, at which the third wave reaches a predetermined value, and time, at which a fourth wave reaches a predetermined value, and the like and regard the time interval as the pressure vibration cycle. Also, for example, the measurement unit may measure the time interval between the time, at which the second wave reaches the predetermined value, and the time, at which the third wave reaches the predetermined value, the time interval between the time, at which the third wave reaches the predetermined value, and the time, at which the fourth wave reaches the predetermined value, and the like and regard an average value as the pressure vibration cycle. Alternatively, the measurement unit may measure the time interval, at which the second wave reaches the predetermined value, and the time, at which the third wave reaches the predetermined value, the time interval between the time, at which the third wave reaches the predetermined value, and the time, at which the fourth wave reaches the predetermined value, and the like and regard, as the pressure vibration cycle, a measurement value when a difference between continuous measurement values is smaller than a threshold value.

(3) In the dissolved gas content measurement apparatus according to the above aspect, the measurement unit may measure the cycle by using a time interval, at which pressure of the pressure vibration in the liquid reaches a peak. According to the dissolved gas content measurement apparatus, it is possible to relatively easily measure the pressure vibration cycle of the liquid. For example, the measurement unit may measure, as the pressure vibration cycle, any one of a time interval between time, at which the second wave reaches a peak, and time, at which the third wave reaches a peak, and a time interval between time, at which the third wave reaches the peak, and time, at which the fourth wave reaches a peak, and the like and regard the time interval as the pressure vibration cycle. Also, for example, the measurement unit may measure the time interval between the time, at which the second wave reaches the peak, and the time, at which the third wave reaches the peak, the time interval between the time, at which the third wave reaches the peak, and the time, at which the fourth wave reaches the peak, and the like and regard an average value as the pressure vibration cycle. Alternatively, the measurement unit may measure the time interval between the time, at which the second wave reaches the peak, and the time, at which the third wave reaches the peak, the time interval between the time, at which the third wave reaches the peak, and the time, at which the fourth wave reaches the peal, and the like and regard, as the pressure vibration cycle, a measurement value when a difference between continuous measurement values is smaller than a threshold value.

(4) In the dissolved gas content measurement apparatus according to the above aspect, the measurement unit may measure the cycle by using a time interval, at which pressure of the pressure vibration in the liquid reaches a maximum value.

(5) In the dissolved gas content measurement apparatus according to the above aspect, the pressure changing unit may include a piezoelectric element and use the piezoelectric element to change the inner pressure of the liquid containing chamber. Since the pressure in the liquid containing chamber is changed by the piezoelectric element according to the dissolved gas content measurement apparatus, it is possible to electrically control the pressure change. In addition, a magnetostrictor may also be used as the pressure changing unit.

In the dissolved gas content measurement apparatus according to the above aspect, the piezoelectric element may be further distorted by the pressure change in the liquid containing chamber, and the measurement unit may measure the pressure vibration cycle of the liquid based on the distortion of the piezoelectric element. According to the dissolved gas content measurement apparatus, it is possible to cause the same piezoelectric element to change the pressure and measure the pressure vibration cycle of the liquid.

(6) In the dissolved gas content measurement apparatus according to the above aspect, the pressure changing unit may include a piezoelectric element and use the piezoelectric element to change the inner pressure of the liquid containing chamber, the measurement unit may include a current detecting circuit which detects current flowing through the piezoelectric element, and use the current detected by the current detecting circuit to measure the cycle. According to the dissolved gas content measurement apparatus, it is possible to relatively easily measure a behavior of the liquid.

(7) In the dissolved gas content measurement apparatus according to the above aspect, the pressure changing unit may include a piezoelectric element and use the piezoelectric element to change the inner pressure of the liquid containing chamber, the measurement unit may include a current detecting circuit which detects current flowing through the piezoelectric element, and use the current detected by the current detecting circuit to measure the cycle, and the current detecting circuit may include a resistive element and detect the current flowing through the piezoelectric element based on a potential difference between terminals of the resistive element.

In the dissolved gas content measurement apparatus according to the above aspect, the measurement unit may stop detection of the current flowing through the piezoelectric element while the piezoelectric element is driven, and detect the current flowing through the piezoelectric element after the completion of the driving of the piezoelectric element. Since the detection of the current flowing through the piezoelectric element is stopped while the piezoelectric element is driven according to the dissolved gas content measurement apparatus, it is possible to reduce drive loss due to the detection of the current and reduce power consumption. In addition, since the current flowing through the piezoelectric element is detected after completing the driving of the piezoelectric element, it is possible to improve an S/N ratio of the current detection without affecting driving efficiency of the piezoelectric element.

(8) In the dissolved gas content measurement apparatus according to the aspect, the pressure changing unit may include a piezoelectric element and use the piezoelectric element to change the inner pressure of the liquid containing chamber, the measurement unit may include a current detecting circuit which detects current flowing through the piezoelectric element and use the current detected by the current detecting circuit to measure the cycle, the current detecting circuit may include a resistive element and detect the current flowing through the piezoelectric element based on a potential difference between terminals of the resistive element, and the current detecting circuit may further include a switch circuit which is connected to the resistive element in parallel, detect a potential difference which is caused by ON resistance of the switch circuit when the switch circuit is turned on, and detect the potential difference between the terminals of the resistive element when the switch circuit is turned off.

(9) In the dissolved gas content measurement apparatus according to the above aspect, the pressure changing unit may include a piezoelectric element and use the piezoelectric element to change the inner pressure of the liquid containing chamber, the measurement unit may include a current detecting circuit which detects current flowing through the piezoelectric element and use the current detected by the current detecting circuit to measure the cycle, the current detecting circuit may include a resistive element and detect the current flowing through the piezoelectric element based on a potential difference between terminals of the resistive element, and the current detecting circuit may further include a switch circuit which is connected to the resistive element in parallel, detect a potential difference which is caused by ON resistance of the switch circuit when the switch circuit is turned on, detect the potential difference between the terminals of the resistive element when the switch circuit is turned off, and maintain the switch circuit in an ON state when the piezoelectric element is driven. According to the dissolved gas content measurement apparatus, it is possible to easily select whether to stop the current detection by causing the current flowing through the piezoelectric element not to flow through the resistive element while the piezoelectric element is driven and causing the current flowing through the piezoelectric element to flow through the resistive element after completing the driving of the piezoelectric element. In addition, the switch circuit may be connected to the resistive element in series such that the current flowing through the piezoelectric element does not flow through the resistive element when the switch circuit is turned off.

(10) In the dissolved gas content measurement apparatus according to the above aspect, the pressure changing unit may include a piezoelectric element and use the piezoelectric element to change the inner pressure of the liquid containing chamber, the measurement unit may include a current detecting circuit which detects current flowing through the piezoelectric element and use the current detected by the current detecting circuit to measure the cycle, the current detecting circuit may include a resistive element and detect the current flowing through the piezoelectric element based on a potential difference between terminals of the resistive element, and the current detecting circuit may further include a switch circuit which is connected to the resistive element in parallel, detect a potential difference which is caused by ON resistance of the switch circuit when the switch circuit is turned on, and detect the potential difference between the terminals of the resistive element when the switch circuit is turned off, and bring the switch circuit into an OFF state when the current flowing through the piezoelectric element is detected.

(11) In the dissolved gas content measurement apparatus according to the above aspect, the pressure changing unit may include a piezoelectric element and use the piezoelectric element to change the inner pressure of the liquid containing chamber, the pressure changing unit may further include a control unit which outputs a drive waveform signal, and an amplifier circuit which amplifies the drive waveform signal and outputs the drive waveform signal to the piezoelectric element, the measurement unit may include a current detecting circuit which detects current flowing through the piezoelectric element and use the current detected by the current detecting circuit to measure the cycle, and the measurement unit may further include an integration circuit which integrates the current detected by the current detecting circuit, and a subtraction circuit which outputs a difference between an output of the integration circuit and the drive waveform signal.

(12) In the dissolve gas content measurement apparatus according to the above aspect, the liquid may be contained in a container, the liquid containing chamber may communicate with one end of the flow path, and the other end of the flow path may be connected to the container. According to the dissolved gas content measurement apparatus, it is possible to measure the dissolved gas content of the liquid which is contained in the container.

(13) In the dissolved gas content measurement apparatus according to the above aspect, the liquid containing chamber may communicate with one end of the flow path, and the other end of the flow path may be detachably connected to the container. According to the dissolved gas content measurement apparatus, it is possible to detach the flow path from the container and to thereby simply measure the dissolved gas content.

(14) Another aspect of the invention provides a liquid treatment apparatus which uses a dissolved gas content measurement apparatus. According to the liquid treatment apparatus, it is possible to directly perform the measurement without changing the liquid into another state. Therefore, it is possible to alleviate restrictions relating to measurement targets and measurement environments.

(15) Still another aspect of the invention provides a dissolved gas content measurement apparatus which measures dissolved gas content in a liquid. The dissolved gas content measurement apparatus includes: a flow path which includes a flow path resistance; a liquid containing chamber which communicates with the flow path; a piezoelectric element; and a drive circuit which applies a drive signal to the piezoelectric element, the drive circuit may detect current flowing through the piezoelectric element in a state where the liquid is contained in the flow path and the liquid containing chamber, and use the detected current and a lookup table or a predetermined function to measure the dissolved gas content.

(16) Yet another aspect of the invention provides a dissolved gas content measurement apparatus which measures dissolved gas content in a liquid. The dissolved gas content measurement apparatus includes: a flow path which includes a flow path resistance; a liquid containing chamber which communicates with the flow path; a pressure changing unit which changes inner pressure of the liquid containing chamber; a measurement unit which measures pressure values and time of a plurality of waves in pressure vibration, which are caused when the pressure changing unit operates, in a state where the liquid is contained in the flow path and the liquid containing chamber; and an obtaining unit which obtains a pressure vibration cycle of the liquid by using a measurement result of the measurement unit and obtains the dissolved gas content.

Still yet another aspect of the invention provides a liquid compression rate measurement apparatus which measures a compression rate of a liquid. The liquid compression rate measurement apparatus includes: a flow path which includes a flow path resistance, a liquid containing chamber which communicates with the flow path; a pressure changing unit which changes inner pressure of the liquid containing chamber; a measurement unit which measures a pressure vibration cycle of the liquid, which is caused when the pressure changing unit operates, in a state where the liquid is contained in the flow path and the liquid containing chamber; and an obtaining unit which obtains the compression rate of the liquid based on the cycle. Since the compression rate of the liquid is obtained based on the pressure vibration cycle of the liquid according to the liquid compression rate measurement apparatus, it is possible to simplify the structure and a measurement method as compared with a case where the liquid is actually pressurized and the compression rate is obtained from volume before and after the pressurization.

All the plurality of constituents in the aforementioned aspects of the invention are not necessarily provided, and modifications, deletions, replacement with another new constituent, partial deletion of limitations of the constituents as a part of the plurality of constituents can be appropriately made in order to solve a part of or entire problems described above or achieve a part of or entire effects described in this specification. In addition, it is also possible to combine, as an independent aspect of the invention, a part of or the entire technical features included in an aspect of the aforementioned invention with a part of or entire technical features included in another aspect of the aforementioned invention in order to solve a part of or the entire aforementioned problems or achieve a part of or the entire effects described in the specification.

In addition, it is possible so solve at least one of various problems, such as a decrease in apparatus size, cost reduction, resource saving, facilitation of manufacturing, and enhancement of usability.

In addition, the invention can be implemented in various forms. For example, the invention can be implemented in the form of a liquid physical property measurement apparatus, a liquid physical property measurement method, a water quality measurement apparatus, and a water quality measurement method. The invention can be applied to a dissolved gas content measurement apparatus in various liquid treatment apparatuses such as an industrial water manufacturing apparatus, a daily life water manufacturing apparatus, an industrial-use liquid processing apparatus, and a sewage treatment apparatus, and particularly, it is possible to provide a liquid treatment apparatus at low costs.

### BRIEF DESCRIPTION OF THE DRAWINGS

The invention will be described with reference to the accompanying drawings, wherein like numbers reference like elements.

FIG. 1 is an illustrative diagram illustrating a measurement system.

FIG. 2 is a block diagram illustrating a configuration of a drive circuit according to a first embodiment.

FIGS. 3A to 3C are illustrative diagrams showing a voltage signal and a detection signal.

FIG. 4 is a graph showing a relationship between an inherent vibration cycle and dissolved gas content which is actually measured.

FIG. 5 is a block diagram illustrating a configuration of a drive circuit according to a second embodiment.

FIGS. 6A to 6D are diagrams showing signal waveforms of the drive circuit.

FIGS. 7A and 7B are illustrative diagrams showing an example of variations in inner pressure of a pump chamber.

FIG. 8 is an illustrative diagram showing a mode of a dissolved gas content measurement apparatus according to Modification Example 2.

### DESCRIPTION OF EXEMPLARY EMBODIMENTS

Hereinafter, a detailed description will be given of preferable embodiments of the invention with reference to drawings. In addition, the embodiments described below are not intended to unduly limit the scope of the invention described in the aspects of the invention. Moreover, all the configurations described below are not necessarily essential requirements of the invention.

### A. First Embodiment

### A1. System Configuration

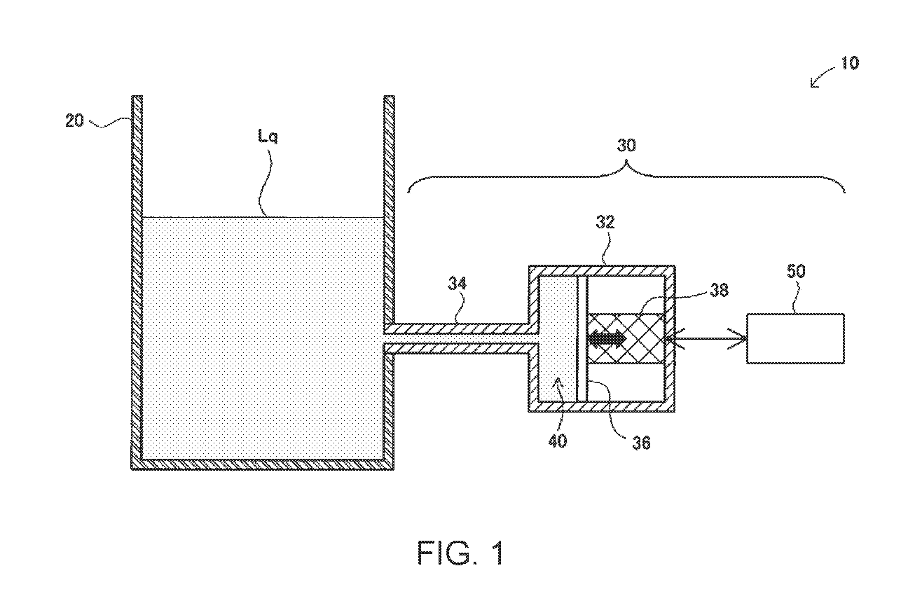

FIG. 1 is an illustrative diagram illustrating a measurement system 10 using a dissolved gas content measurement apparatus 30 according to a first embodiment of the invention. The dissolved gas content measurement apparatus 30 is an apparatus which measures content of gas dissolved in a liquid.

The measurement system 10 is provided with a container 20 which contains a liquid Lq as a measurement target and the dissolved gas content measurement apparatus 30. According to this embodiment, the liquid Lq contained in the container 20 is water. In addition, the gas dissolved in the liquid Lq is one of various kinds of gas such as oxygen, nitrogen, or hydrogen or a combination thereof.

The dissolved gas content measurement apparatus 30 is provided with a case body 32, a flow path 34, a diaphragm 36, a piezoelectric element 38, and a drive circuit 50. The case body 32 includes a pump chamber 40 provided therein. The pump chamber 40 is formed by an inner wall of the case body 32 and the diaphragm 36. The flow path 34 is connected to the container 20 so as to cause the pump chamber 40 to communicate with the container 20. Therefore, the flow path 34 and the pump chamber 40 are filled with the liquid Lq (water in this embodiment) as a measurement target. The pump chamber 40 may be provided with an outgassing hole with a cover, which is for outgassing in the pump chamber 40 before measurement in order to fill the pump chamber 40 with the liquid Lq. In this embodiment, the container 20 and the case body 32 are configured of significantly hard members. For example, stainless steel can be employed.

The piezoelectric element 38 has one end fixed to the diaphragm 36 and the other end fixed to the inner wall of the case body 32. According to this embodiment, a laminated piezoelectric element is used as the piezoelectric element 38. However, the invention is not limited thereto, and a monomorph or bimorph piezoelectric element may be employed. The piezoelectric element 38 is connected to the drive circuit 50 and expands and contracts in response to a drive signal (power) applied from the drive circuit 50. The piezoelectric element 38 pushes and draws the diaphragm 36 by distortion force caused by the expansion and contraction and indirectly pressurizes and depressurizes the water in the pump chamber 40 by changing the volume of the pump chamber 40. The diaphragm 36 and the piezoelectric element 38 correspond to the pressure changing unit described in the aspects of the invention.

The drive circuit 50 applies the drive signal to the piezoelectric element 38 and detects variations in the inner pressure of the pump chamber 40. Specifically, if the inner pressure of the pump chamber 40 varies, force is applied to the piezoelectric element 38 via the diaphragm 36. The piezoelectric element 38 generates voltage by a piezoelectric effect. The drive circuit 50 detects variations in the inner pressure of the pump chamber 40 by detecting the voltage which is generated by the piezoelectric element 38. The drive circuit 50 measures dissolved gas content in the water as a measurement target based on the variations in the inner pressure of the pump chamber 40, which is detected under a predetermined condition, as will be described later.

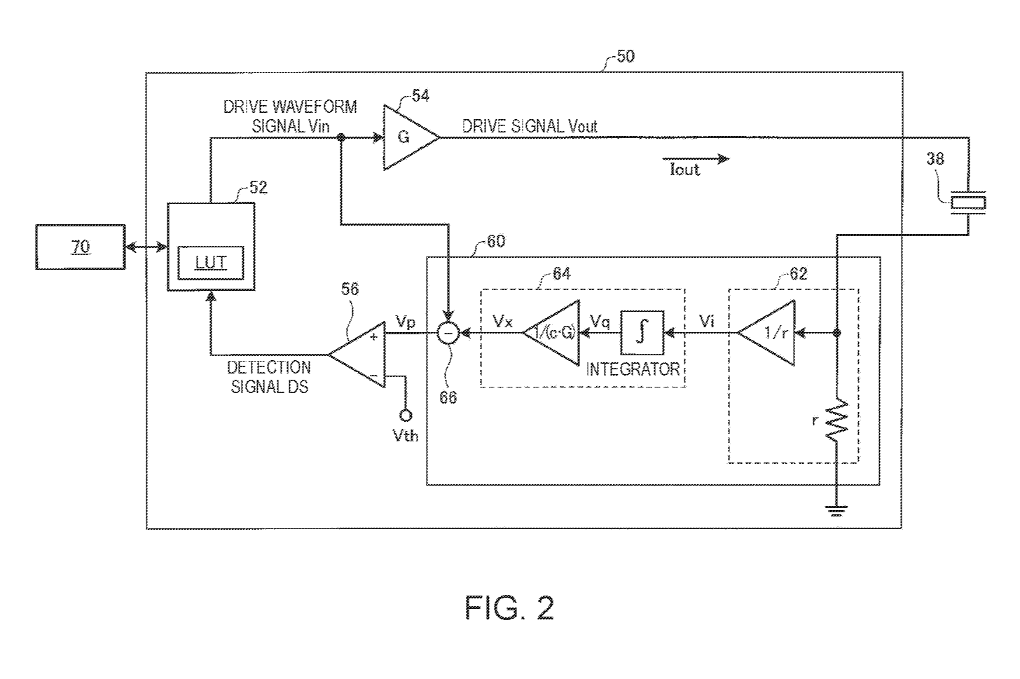

FIG. 2 is a block diagram illustrating a configuration of the drive circuit 50. The drive circuit 50 is provided with a control unit 52 which outputs a drive waveform signal Vin, an amplifier circuit 54 which amplifies the drive waveform signal Vin at an amplification factor G and outputs a drive signal Vout to the piezoelectric element 38, a pressure detecting unit 60 which detects the inner pressure of the pump chamber 40, a comparison unit 56 which compares the detected inner pressure with a predetermined threshold value, and a display unit 70. The pressure detecting unit 60 is provided with a resistive element r, a current detecting circuit 62 which detects drive current flowing through the piezoelectric element 38 based on a potential difference between terminals of the resistive element r, an integration circuit 64 which integrates the detected drive current, and a subtraction circuit 66 which outputs a difference between an output from the integration circuit 64 and the drive waveform signal Vin.

The drive circuit 50 detects a pressure signal Vp, which indicates the inner pressure of the pump chamber 40, as follows. The control unit 52 outputs the drive waveform signal Vin. The drive waveform signal Vin is amplified by the amplifier circuit 54 and applied as the drive signal Vout to the piezoelectric element 38. At this time, drive current lout corresponding to the drive signal Vout flows into the piezoelectric element 38. The resistive element r which is used for detecting current is connected to the other end of the piezoelectric element 38. The other end of the resistive element r is connected to a reference potential. The current detecting circuit 62 converts the potential difference between the terminals of the resistive element r, which is caused by the drive current lout, into a signal Vi by dividing the potential difference by a resistance value of the resistive element r and inputs the signal Vi to the integration circuit 64. The integration circuit 64 integrates the input signal Vi by an integrator and outputs an electric charge signal Vq which is a value corresponding to the amount of electric charge accumulated in the piezoelectric element 38.

The drive current Tout (signal Vi) which flows through the piezoelectric element 38 is proportional to a displacement rate of the piezoelectric element 38. Therefore, the amount of electric charge accumulated in the piezoelectric element 38 (charge signal Vq) is proportional to the displacement of the piezoelectric element 38. Ina state where the piezoelectric element 38 can freely expand and contract, the displacement of the piezoelectric element 38 is substantially proportional to the drive signal. On the other hand, if the inner pressure of the pump chamber 40 varies, pressure change affects the piezoelectric element 38 via the diaphragm 36. Since the piezoelectric element 38 expands and contracts (displaces) in proportion to the pressure change which affects the piezoelectric element 38, a difference between displacement of the piezoelectric element 38 in a case where the pressure change in the pump chamber 40 affects the piezoelectric element 38 and original displacement of the piezoelectric element 38 (a difference from a case where the pressure change does not affect the piezoelectric element 38) is proportional to the pressure applied to the piezoelectric element 38 (inner pressure of the pump chamber 40).

The pressure detecting unit 60 obtains a voltage signal Vx by dividing the electric charge signal Vq which is obtained by the integrator of the integration circuit 64 by an equivalent electrostatic capacitance c of the piezoelectric element 38 and the amplification factor G of the amplifier circuit 54. The pressure detecting unit 60 calculates a difference between the voltage signal Vx corresponding to actual displacement of the piezoelectric element 38 and the drive waveform signal Vin by the subtraction circuit 66 and obtains the pressure signal Vp corresponding to the inner pressure of the pump chamber 40.

The pressure detecting unit 60 inputs the obtained pressure signal Vp to the comparison unit 56. The comparison unit 56 generates a binarized detection signal DS by comparing the pressure signal Vp with a predetermined threshold value and inputs the detection signal DS to the control unit 52. The control unit 52 is provided with a lookup table LUT, detects current flowing through the piezoelectric element 38 in a state where the liquid Lq is contained on the flow path 34 and the pump chamber 40, and measures the dissolved gas content in the liquid Lq by using the detected current and the lookup table LUT. More specifically, the control unit 52 obtains the dissolved gas content in the water based on the input detection signal DS and the lookup table LUT. Then, the obtained dissolved gas content is displayed on the display unit 70 such that a user can visually recognize the dissolved gas content. In addition, a method for obtaining the dissolved gas content based on the lookup table LUT and the detection signal DS will be described later.

### A2. Pressure Vibration

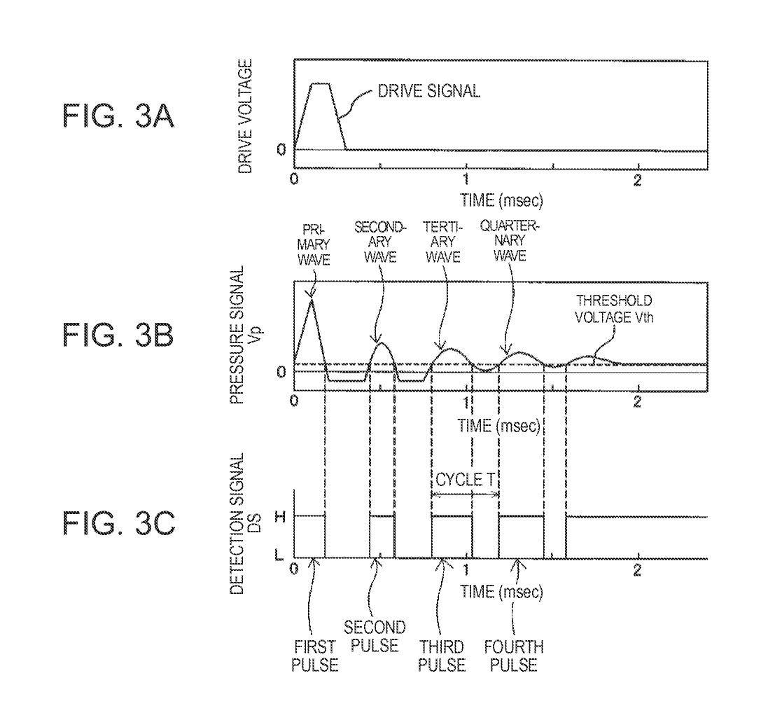

FIGS. 3A to 3C are illustrative diagrams showing examples of the pressure signal Vp obtained by the pressure detecting unit 60 and the detection signal DS obtained by the comparison unit 56 when the drive signal Vout is applied to the piezoelectric element 38. FIG. 3A shows the drive signal Vout to be applied to the piezoelectric element 38. FIG. 3B shows the pressure signal Vp obtained by the pressure detecting unit 60. FIG. 3C shows the detection signal DS obtained by the comparison unit 56.

As shown in FIG. 3A, one-pulse Vin is output from the control unit 52, and the drive signal Vout is applied to the piezoelectric element 38 in this embodiment. If voltage (drive voltage) of the drive signal Vout increases, the piezoelectric element 38 expands and pressurizes the liquid Lq in the pump chamber 40 via the diaphragm 36. As a result, the voltage of the drive signal Vout rises, and the inner pressure of the pump chamber 40 steeply increases as shown in FIG. 3B. Displacement of the piezoelectric element 38 does not vary while the drive voltage is maintained at predetermined set voltage. For this reason, a pressure difference occurs between the liquid Lq in the pump chamber 40 and the liquid Lq in the container 20, and the liquid Lq flows from the pump chamber 40 to the container 20 (see FIG. 1). The inner pressure of the pump chamber 40 decreases as the liquid Lq flows into the container 20. At this time, inertial force works on the liquid Lq, which passes through the flow path 34, by inertance of the flow path 34, and the liquid Lq tries to keep flowing from the pump chamber 40 to the container 20. As a result, the inner pressure of the pump chamber 40 becomes lower (negative pressure) than the pressure in the container 20, and if the inner pressure of the pump chamber 40 further decreases to a level of saturated vapor pressure of the liquid Lq (water in this embodiment) as a measurement target, cavitation occurs, and the inner pressure is maintained to be substantially constant. In addition, the inertance will be described in detail later.

Then, the pump chamber 40 absorbs the liquid Lq from the container 20 if the inner pressure becomes negative pressure. Therefore, the liquid Lq flows from the container 20 into the pump chamber 40. Even in such a case, the liquid Lq tries to keep flowing from the container 20 to the pump chamber 40 by the inertial force based on the inertance of the flow path as described above. Therefore, the inner pressure of the pump chamber 40 increases as shown in FIG. 3B. As described above, the inner pressure of the pump chamber 40 vibrates due to the inertial force caused by the inertance of the flow path 34. As can be understood from FIG. 3B, the vibration of the inner pressure of the pump chamber 40 has a predetermined frequency.

Here, a wave of the pressure vibration, in which the inner pressure of the pump chamber 40 rises one time and falls one time when the drive signal Vout is applied to the piezoelectric element 38 as shown in FIG. 3B, will be referred to as a first wave. Waves of the pressure vibration following the first wave will be referred to as a second wave, a third wave, a fourth wave, and the like. As shown in FIG. 3C, the detection signal DS is a signal corresponding to the waves (the first wave, the second wave, and the like) of the pressure vibration of the pump chamber 40. Pulses of the detection signal DS corresponding to the respective pressure vibration will be referred to as a first pulse, a second pulse, and the like.

### A3. Resonance Model Based on Compression Property of Liquid

The vibration phenomenon of the inner pressure of the pump chamber 40 as described above can be explained based on a resonance mode in consideration of a compression property of the liquid Lq. The liquid Lq is generally incompressible. However, when gas is dissolved in the liquid, the liquid Lq obtains a compression property due to a compression property of the dissolved gas. If the liquid Lq has the compression property, vibration of the pressure occurs due to a pressure difference between the pump chamber 40 and the container 20 and the inertial force of the inertance of the flow path 34.

Here, a resonance model of the pressure vibration of the liquid Lq in the pump chamber 40, the container 20, and the flow path 34 will be assumed. An inherent vibration cycle T in the resonance model is represented by the following Equation (1).

T=2π(MC)^{1/2} (1)

In Equation (1), M represents the inertance of the flow path 34. C represents synthesized compliance of compliance of the pump chamber 40 and compliance of the container 20. The synthesized compliance C is represented by the following Equation (2) where C1 represents the compliance of the pump chamber 40 and C2 represents the compliance of the container 20.

C=1/{1/C1+1/C2} (2)

The compliance represents volume expansion and fluid compression caused by deformation of a fluid chamber when pressure is applied to the inside of the fluid chamber. For example, when a fluid chamber with a volume V and volume elasticity K is filled with the liquid Lq with a compression rate _{K}F and pressure P is applied to the liquid Lq in the fluid chamber, a volume change ΔVa caused by the deformation of the fluid chamber can be represented by the following Equation (3). In addition, a volume change ΔVb of the fluid chamber due to compression of the liquid Lq is represented by the following Equation (4).

ΔVa=V/K×P (3)

ΔVb=V/κ_{F}×P (4)

Therefore, an apparent volume change amount ΔV of the fluid chamber with respect to the pressure P is represented by the following Equation (5).

ΔV=ΔVa+ΔVb=V×(1/K+κ_{F})×P (5)

V×(1/K+_{K}F) in Equation (5) is compliance of the fluid chamber. Therefore, the compliance C1 of the container 20 and the compliance C2 of the pump chamber 40 in this embodiment are represented by the following Equations (6) and (7).

C1=V1×(1/K+κ_{F}) (6)

C2=V2×(1/K+κ_{F}) (7)

In Equations (6) and (7), V1 represents the volume of the container 20, and V2 represents the volume of the pump chamber 40. Since the case body 32 which configures the container 20 and the pump chamber 40 is configured of a significantly hard member such as stainless steel as described above in this embodiment, the elasticity K becomes a significantly large value. That is, (1/K) in Equations (6) and (7) is a minute value. This means that the volume changes of the container 20 and the pump chamber 40 are minute. Therefore, the volume changes of the container 20 and the pump chamber 40 hardly affect the value of the compliance. Therefore, (1/K) in Equations (6) and (7) can be approximated to 0. Furthermore, it is assumed that the volume V1 of the container 20 is sufficiently larger than the volume V2 of the pump chamber 40 in this embodiment. Therefore, C1>>C2 is satisfied in Equations (6) and (7). In such a case, the compliance C2 of the container 20 is a term which can be ignored in the synthesized compliance C calculated by Equation (2). Therefore, the inherent vibration cycle T can be represented by the following Equation (8) based on Equations (1), (2), and (7).

T=2π{M·V2·κ_{F}}^{1/2} (8)

It can be understood from Equation (8) that the inherent vibration cycle T is proportional to a square root of the compression rate _{K}F of the liquid Lq. If it is assumed that the compression rate _{K}F of the liquid Lq increases as the dissolved gas content in the liquid increases, the inherent vibration cycle T increases as the dissolved gas content increases based on Equation (8).

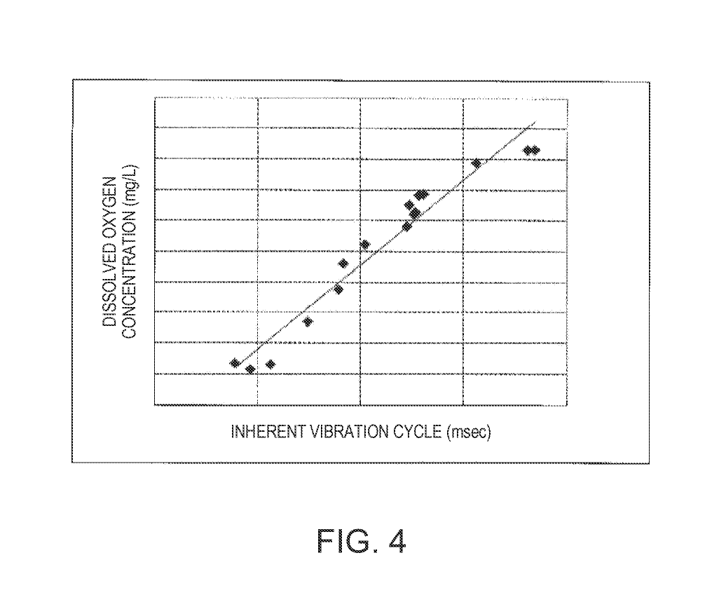

Next, it will be described that “the inherent vibration cycle T increases as the dissolved gas content increases” based on actual measurement. FIG. 4 is a graph showing a relationship between the inherent vibration cycle T and the dissolved gas content, which are obtained in actual measurement, of the measurement system 10. The vertical axis of the graph represents the dissolved gas content in the liquid Lq in the container 20. In this measurement, the dissolved gas content in the liquid Lq is measured by a commercially available dissolved gas measurement apparatus. The horizontal axis of the graph represents the inherent vibration cycle T. As the inherent vibration cycle T, time from the detection of the third pulse of the detection signal DS to the detection of the fourth pulse is employed (see FIGS. 3A to 3C). It can be understood from FIG. 4 that the inherent vibration cycle T increases as the dissolved gas content increases. That is, a correlation between the dissolved gas content and the inherent vibration cycle T that “the inherent vibration cycle T increases as the dissolved gas content increases” is shown by actual measurement.

### A4. Measurement of Dissolved Gas Content and Liquid Compression Rate

The control unit 52 measures the inherent vibration cycle T of the liquid Lq, which is caused when the diaphragm 36 and the piezoelectric element 38 operate, in a state where the liquid Lq is contained in the flow path 34 and the pump chamber 40 and acquires the dissolved gas amount in the liquid Lq based on the inherent vibration cycle T. More specifically, the control unit 52 measures pressure values and time of a plurality of waves (at least a part of the second wave, the third wave, the fourth wave, . . . ) in the pressure vibration, which are caused when the diaphragm 36 and the piezoelectric element 38 operate, in the state where the liquid Lq is contained in the flow path 34 and the pump chamber 40, obtains the inherent vibration cycle T of the liquid Lq by using the measurement results, and obtains the dissolved gas amount in the liquid Lq.

According to this embodiment, the control unit 52 includes the correlation (FIG. 4) between the dissolved gas content and the inherent vibration cycle T, which are actually measured as described above, as the lookup table LUT (see FIG. 2). When the dissolved gas content is actually measured, the control unit 52 applies the one-pulse drive signal Vout to the piezoelectric element 38, causes pressure vibration in the pump chamber 40, and extracts the inherent vibration cycle T from the detected detection signal DS. Then, the control unit 52 inputs the obtained inherent vibration cycle T to the lookup table LUT. The control unit 52 obtains the dissolved gas content which is output from the look up table LUT in accordance with the inherent vibration cycle T.

In this embodiment, the control unit 52 uses a time interval, at which the pressure of the pressure vibration in the liquid Lq reaches a predetermined value, to measure the inherent vibration cycle T. More specifically, the control unit 52 measures the inherent vibration cycle T based on the detection signal DS generated by using current which is detected by the current detecting circuit 62. In this embodiment, time from the detection of the third pulse of the detection signal DS to the detection of the fourth pulse is employed as the time interval, at which the pressure of the pressure vibration in the liquid Lq reaches the predetermined value, and the time interval is regarded as the inherent vibration cycle T. The inherent vibration cycle T corresponds to time interval between time, at which the third wave of the pressure vibration reaches a predetermined value, and time at which the fourth wave reaches a predetermined value.

Thereafter, the control unit 52 displays the value of the obtained dissolved gas content on the display unit 70 such that the user can visually recognize the value. The control unit 52 may be provided with lookup tables LUT for various kinds of liquid such as water, predetermined oil, and predetermined organic solvent. It is possible to cause the control unit 52 to include such lookup tables by actually measuring a correlation between dissolved gas content and the inherent vibration cycle T and generating lookup tables for the respective kinds of liquid.

Furthermore, the control unit 52 can calculate the compression rate _{K}F of the liquid Lq by using the inherent vibration cycle T which is obtained by actual measurement and Equation (8). The control unit 52 displays the calculated compression rate _{K}F along with the dissolved gas content on the display unit 70. As described above, the dissolved gas content measurement apparatus 30 measures the dissolved gas content and the compression rate _{K}F.

Although the control unit 52 measures the dissolved gas content by using the lookup table LUT in this embodiment, the control unit 52 may detect the current flowing through the piezoelectric element 38 and measure the dissolved gas content in the liquid Lq by using the detected current and a predetermined function in a state where the liquid Lq is contained in the flow path 34 and the pump chamber 40. The predetermined function may be a function which represents a correlation between the dissolved gas content and the inherent vibration cycle T (FIG. 4, for example). The control unit 52 can calculate the dissolved gas content from the predetermined function and the inherent vibration cycle T.

Next, the inertance used in the description of this embodiment will be described. The inertance is a value of a property of the flow path. Specifically, the inertance represents how easily fluid in the flow path flows when the fluid tries to flow by application of pressure to one end of the flow path. For example, it is assumed that the flow path with a cross-sectional area S and a length L is filled with fluid (liquid Lq in this embodiment) at a density ρ, and that pressure P (pressure difference between both ends) is applied to one end of the flow path. Force of P×S acts on the fluid in the flow path. As a result, the liquid Lq in the flow path starts to flow. When a represents acceleration of the fluid, the following motion equation represented as Equation (9) is satisfied.

P×S=ρ×S×L×a (9)

When Q represents a volumetric flow amount flowing through the flow path and v represents a flow rate of the fluid flowing through the flow path, the following Equations (10) and (11) are obtained.

Q=v×S (10)

dQ/dt=a×S (11)

The following Equation (12) can be obtained from Equations (10) and (11).

P=(ρ×L/S)×(dQ/dt) (12)

Equation (12) represents that dQ/dt increases (that is, the flow rate significantly varies) as (ρ×L/S) decreases if the same pressure P is applied. (ρ×L/S) is the value called the inertance. That is, M=(ρ×L/S) is satisfied in Equations (1) and (8). The above description was given of the inertance.

As described above, the dissolved gas content measurement apparatus 30 can measure the dissolved gas content in the liquid Lq and the compression rate _{K}F of the liquid Lq by using resonance of the pressure vibration between the container 20 and the pump chamber 40. Therefore, it is possible to directly perform the measurement in the state of the liquid Lq (it is not necessary to perform the measurement in a gas phase).

In addition, it is possible to measure the dissolved gas content and the compression rate _{K}F if the state where the flow path 34 and the pump chamber 40 are filled with the liquid Lq as a measurement target can be maintained during the measurement. Therefore, it is possible to alleviate the restrictions relating to the measurement targets and the measurement environments of the dissolved gas content and the compression rate _{K}F. For example, a tank for industrial use which contains liquid is generally provided with a through hole, into which a thermometer is inserted, and a through hole for discharging drain. It is possible to measure the dissolved gas content and the compression rate _{K}F of the liquid which is contained in the tank by connecting the flow path 34 of the dissolved gas content measurement apparatus 30 to such through holes. According to one example, it is possible to install the dissolved gas content measurement apparatus 30 in a liquid treatment apparatus. It is possible to easily measure water quality (dissolved gas content) by installing the dissolved gas content measurement apparatus 30 in the tank for containing water to be treated or water after a treatment. As a specific liquid treatment apparatus, it is possible to exemplify a water cleaner for industrial use. In addition, it is also possible to apply the dissolved gas content measurement apparatus 30 not only to the liquid treatment apparatus for industrial use but also to a liquid treatment apparatus for domestic use (home use water cleaner).

Since the pressurization of the pump chamber 40 and the measurement of the inner pressure of the pump chamber 40 are performed by a single piezoelectric element 38 in this embodiment, it is possible to simplify the structure and reduce the size and the cost of the structure as compared with a case where the pressurization and the measurement are performed by different elements or apparatuses.

As for the correspondence with the aspects of the invention, the pump chamber 40 corresponds to a liquid containing chamber in the aspects. The diaphragm 36 and the piezoelectric element 38 correspond to the pressure changing unit in the aspects. The inherent vibration cycle T corresponds to the pressure vibration cycle of the liquid in the aspects. The piezoelectric element 38 and the drive circuit 50 correspond to the measurement unit in the aspects. The drive circuit 50 (control unit 52) corresponds to the obtaining unit in the aspects.

### B. Second Embodiment

### B1. System Configuration

Since a configuration of the measurement system 10 using the dissolved gas content measurement apparatus 30 according to the second embodiment of the invention is the same as that in the first embodiment (FIG. 1), a drawing and a description thereof will be omitted. However, the second embodiment is different from the first embodiment in a configuration of the drive circuit 50.

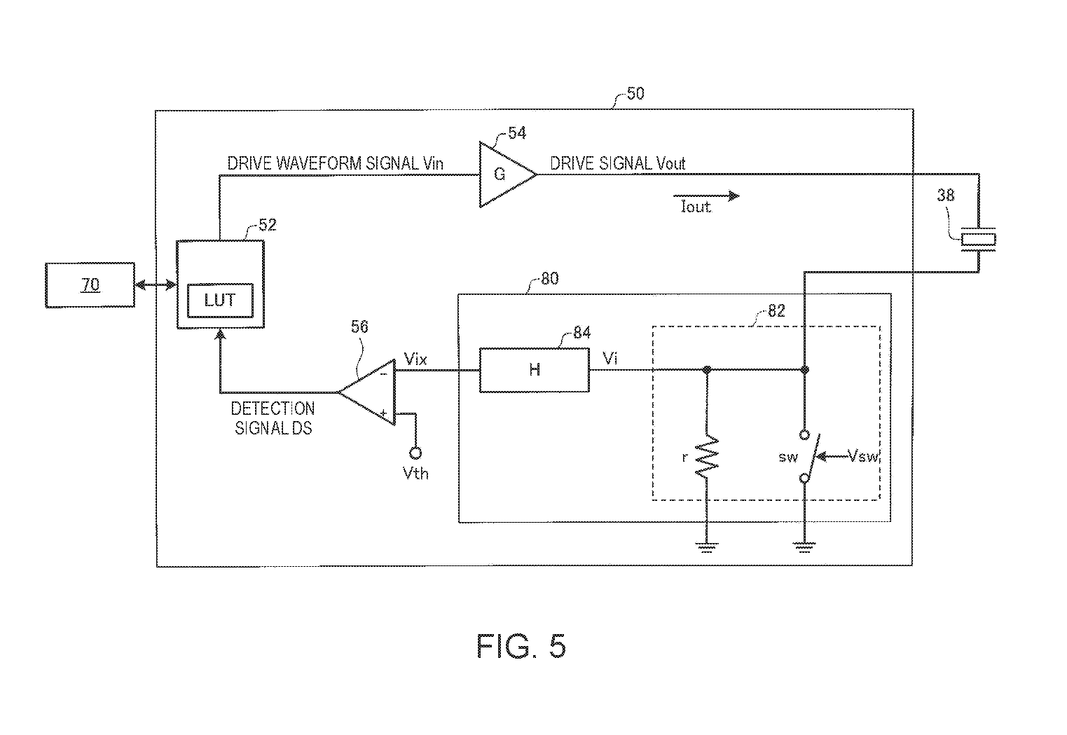

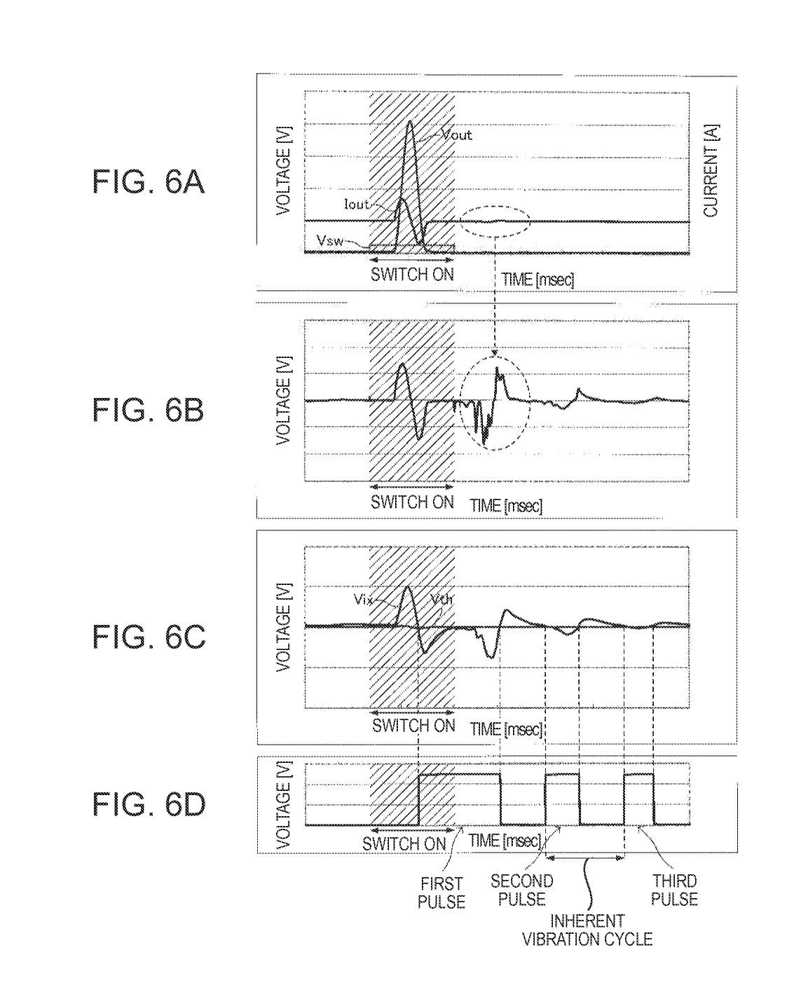

FIG. 5 is a block diagram illustrating the configuration of the drive circuit 50 according to the second embodiment. In addition, FIGS. 6A to 6D are diagrams showing a signal waveform of the drive circuit 50. The drive circuit 50 is provided with the control unit 52 which outputs the drive waveform signal Vin, the amplifier circuit 54 which amplifies the drive waveform signal Vin at the amplification factor G and outputs the drive signal Vout, a pressure change rate detecting unit 80 which detects a change rate of the inner pressure of the pump chamber 40, a comparison unit 56 which compares the detected change rate of the inner pressure with a predetermined threshold value Vth, and the display unit 70. The pressure change rate detecting unit 80 is provided with a resistive element r, a current detecting circuit 82 which detects drive current flowing through the piezoelectric element 38 based on a potential difference between terminals of the resistive element r, and a bandpass filter 84 for removing a DC component and high-frequency noise from a voltage signal which indicates the detected drive current. The current detecting circuit 82 is further provided with a switch sw which is connected to the resistive element r in parallel. According to this embodiment, the current detecting circuit 82 brings the switch sw into an ON state when the piezoelectric element 38 is driven. In addition, the current detecting circuit 82 brings the switch sw into an OFF state when the drive current flowing through the piezoelectric element 38 is detected.

The drive circuit 50 detects a signal Vix, which indicates the change rate of the inner pressure of the pump chamber 40, as follows. The control unit 52 outputs the drive waveform signal Vin. The drive waveform signal Vin is amplified by the amplifier circuit 54 and applied as the drive signal Vout to the piezoelectric element 38. At this time, the drive current lout corresponding to the drive signal Vout flows into the piezoelectric element 38. The resistive element r and the switch sw which are used for detecting current are connected to the other end of the piezoelectric element 38. Both the other end of the resistive element r and the other end of the switch sw are connected to the reference potential. The switch sw is a switch circuit which is turned on and off in accordance with a voltage level of a control signal Vsw and can be implemented by inputting the control signal Vsw to a gate of a MOS transistor, for example.

The control unit 52 controls the voltage level of the control signal Vsw and outputs the drive waveform signal Vin when the switch sw is turned on, and therefore, the drive signal Vout is applied to the piezoelectric element 38, and the drive current lout flows into the piezoelectric element 38. The control unit 52 turns off the switch sw after completing the output of the drive waveform signal Vin. FIG. 6A shows waveform examples of the drive signal Vout, the drive current lout, and the control signal Vsw.

The current detecting circuit 82 detects a potential difference which is caused by ON resistance of the switch sw when the switch sw is turned on, and detects a potential difference between the terminals of the resistive element r when the switch sw is turned off. More specifically, the current detecting circuit 82 converts a potential difference, which is caused by the drive current Tout and the ON resistance of the switch sw, in a case where the switch sw is turned on or a potential difference between the terminals of the resistive element r which is caused by the drive current Tout, in a case where the switch sw is turned off into the signal Vi, respectively, and inputs the signal Vi to the bandpass filter 84. FIG. 6B shows an example of the waveform of the signal Vi.

The bandpass filter 84 allows a signal at a desired frequency band included in the input signal Vi to pass and outputs the signal Vix. The frequency band of the bandpass filter 84 is set so as to include the frequency band of the pressure vibration in the pump chamber 40. FIG. 6C shows examples of waveforms of the signal Vix and the threshold value Vth of the comparison unit 56.

The drive current Tout (signal Vix) flowing through the piezoelectric element 38 is proportional to a displacement rate of the piezoelectric element 38. If the inner pressure of the pump chamber 40 varies, the pressure change affects the piezoelectric element 38 via the diaphragm 36. Since the piezoelectric element 38 expands or contracts (displaces) in proportion to the pressure change which affects the piezoelectric element 38, the displacement rate of the piezoelectric element 38 is proportional to the change rate of the inner pressure of the pump chamber 40. In short, the signal Vix is a signal which indicates the change rate of the inner pressure of the pump chamber 40. Therefore, the change rate of the inner pressure of the pump chamber 40 becomes zero, that is, the inner pressure of the pump chamber 40 reaches a peak (a maximum or a minimum) when the signal Vix corresponds to predetermined reference voltage. Here, since the piezoelectric element 38 expands if the signal Vix is higher than the reference voltage when the piezoelectric element 38 is driven by the amplifier circuit 54, the inner pressure of the pump chamber 40 corresponds to a rising state. Since the piezoelectric element 38 contracts if the signal Vix is lower than the reference voltage, the inner pressure of the pump chamber 40 corresponds to a falling state. Therefore, the drawing shows that the inner pressure of the pump chamber 40 reaches a maximum value at timing, at which the signal Vix is switched from a positive voltage to a negative voltage with respect to the reference voltage. In addition, since the piezoelectric element 38 contracts if the signal Vix is lower than the reference voltage when the piezoelectric element 38 is not driven by the amplifier circuit 54, the inner pressure of the pump chamber 40 corresponds to a falling state. On the other hand, since the piezoelectric element 38 expands if the signal Vix is higher than the reference voltage, the inner pressure of the pump chamber 40 corresponds to a rising state, which represents that the inner pressure of the pump chamber 40 reaches the maximum value at timing, at which the signal Vix is switched from the negative voltage to the positive voltage with respect to the reference voltage.

The pressure change rate detecting unit 80 inputs the obtained signal Vix to the comparison unit 56. The comparison unit 56 generates the binarized detection signal DS by comparing the signal Vix with the predetermined threshold value vth and inputs the detection signal DS to the control unit 52. The threshold value vth is made to coincide with the voltage (reference voltage) of the signal Vix when the change rate of the inner pressure of the pump chamber 40 is zero. FIG. 6D shows an example of a waveform of the detection signal DS. As shown in FIG. 6D, the detection signal DS includes a plurality of pulses (the first pulse, the second pulse, . . . ) by the pressure vibration in the pump chamber 40.

The control unit 52 is provided with the lookup table LUT, detects the current flowing through the piezoelectric element 38 in a state where the liquid Lq is contained in the flow path 34 and the pump chamber 40, and measures the dissolved gas content in the liquid Lq by using the detected current and the lookup table LUT. The control unit 52 obtains the dissolved gas content in water by using the input detection signal DS and the lookup table LUT. Then, the obtained dissolved gas content is displayed on the display unit 70 such that the user can visually recognize the dissolved gas content.

### B2. Measurement of Dissolved Gas Content and Liquid Compression Rate

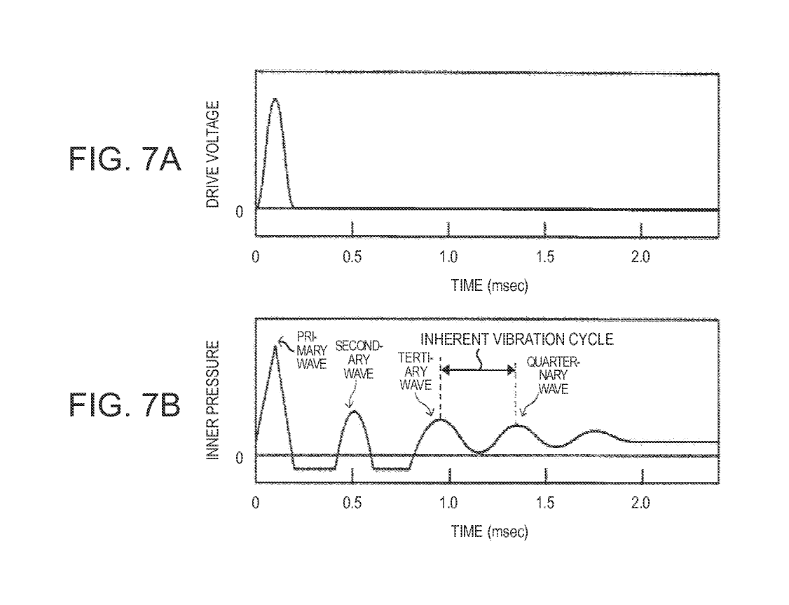

FIGS. 7A and 7B are illustrative diagrams showing an example of the inner pressure change in the pump chamber 40 when the drive signal Vout is applied to the piezoelectric element 38. FIG. 7A shows the drive signal Vout to be applied to the piezoelectric element 38. FIG. 7B shows the inner pressure change in the pump chamber 40. Since the behavior of the inner pressure of the pump chamber 40 was described above in the first embodiment (FIGS. 3A to 3C), the description thereof is not repeated. In this embodiment, the wave of the pressure vibration, in which the inner pressure of the pump chamber 40 rises one time and falls one time by application of the drive signal Vout to the piezoelectric element 38, will be referred to as a first wave, and the waves of the pressure vibration following the first wave will be referred to as a second wave, a third wave, a fourth wave, . . . in the same manner as in the first embodiment.

In the same manner as in the first embodiment, the control unit 52 is provided with a correlation between the dissolved gas content and the inherent vibration cycle T (FIG. 4) as the lookup table LUT (see FIG. 5). When the dissolved gas content is actually measured, the control unit 52 applies a one-pulse drive signal Vout to the piezoelectric element 38, generates pressure vibration in the pump chamber 40, and extracts the inherent vibration cycle T from the detected detection signal DS. Then, the control unit 52 inputs the obtained inherent vibration cycle T to the lookup table LUT. The control unit 52 obtains the dissolved gas content which is output from the lookup table LUT in accordance with the inherent vibration cycle T. In this embodiment, the control unit 52 uses a time interval, at which the pressure of the pressure vibration in the liquid Lq reaches a peak (a maximum value, for example) to measure the inherent vibration cycle T. More specifically, the control unit 52 measures the inherent vibration cycle T based on the detection signal DS generated by using the current which is detected by the current detecting circuit 82. In this embodiment, time from the detection of the second pulse of the detection signal DS to the detection of the third pulse is employed as the time interval, at which the pressure of the pressure vibration in the liquid Lq reaches a peak, (see FIG. 6D), and the time interval is regarded as the inherent vibration cycle T. The inherent vibration cycle T corresponds to a time interval between time, at which the third wave of the pressure vibration reaches a peak (maximum value), and time, at which the fourth wave reaches a peak (maximum value) (see FIG. 7B).

Thereafter, the control unit 52 displays the obtained dissolved gas content on the display unit 70 such that the user can visually recognize the dissolved gas content. The control unit 52 may be provided with lookup tables LUT for various kinds of liquid such as water, predetermined oil, and predetermined organic solvent. It is possible to cause the control unit 52 to include such lookup tables by actually measuring a correlation between dissolved gas content and the inherent vibration cycle T and generating lookup tables for the respective kinds of liquid.

Furthermore, the control unit 52 can calculate the compression rate _{K}F of the liquid Lq by using the inherent vibration cycle T which is obtained in actual measurement and Equation (8). The control unit 52 displays the calculated compression rate _{K}F along with the dissolved gas content on the display unit 70. As described above, the dissolved gas content measurement apparatus 30 measures the dissolved gas content and the compression rate _{K}F.

Although the control unit 52 uses the lookup table LUT to measure the dissolved gas content in this embodiment, the control unit 52 may measure the dissolved gas content of the liquid Lq by detecting the current flowing through the piezoelectric element 38 in a state where the liquid Lq is contained in the flow path 34 and the pump chamber 40 and using the detected current and a predetermined function. The predetermined function may be a function which represents a correlation between the dissolved gas content and the inherent vibration cycle T (FIG. 4, for example). The control unit 52 can calculate the dissolved gas content from the predetermined function and the inherent vibration cycle T.

As described above, the dissolved gas content measurement apparatus 30 according to the second embodiment can measure the dissolved gas content in the liquid Lq and the compression rate _{K}F of the liquid Lq by using resonance of the pressure vibration between the container 20 and the pump chamber 40 in the same manner as in the first embodiment. Therefore, it is possible to directly perform the measurement in the state of the liquid (it is not necessary to perform the measurement in a gas phase).

In addition, it is possible to measure the dissolved gas content and the compression rate _{K}F if the state where the flow path 34 and the pump chamber 40 are filled with the liquid Lq as a measurement target can be maintained during the measurement. Therefore, it is possible to alleviate the restrictions relating to the measurement targets and the measurement environments of the dissolved gas content and the compression rate _{K}F. For example, a tank for industrial use which contains liquid is generally provided with a through hole, into which a thermometer is inserted, and a through hole for discharging drain. It is possible to measure the dissolved gas content and the compression rate _{K}F of the liquid which is contained in the tank by connecting the flow path 34 of the dissolved gas content measurement apparatus 30 to such through holes. According to one example, it is possible to install the dissolved gas content measurement apparatus 30 in a liquid treatment apparatus. It is possible to easily measure water quality (dissolved gas content) by installing the dissolved gas content measurement apparatus 30 in the tank for containing water to be treated or water after a treatment. As a specific liquid treatment apparatus, it is possible to exemplify a water cleaner for industrial use. In addition, it is also possible to apply the dissolved gas content measurement apparatus 30 not only to the liquid treatment apparatus for industrial use but also to a liquid treatment apparatus for domestic use (home use water cleaner).

Since the pressurization of the pump chamber 40 and the measurement of the inner pressure of the pump chamber 40 are performed by a single piezoelectric element 38 in this embodiment, it is possible to simplify the structure and reduce the size and the cost of the structure as compared with a case where the pressurization and the measurement are performed by different elements or apparatuses.

Furthermore, since the potential difference between the terminals of the resistive element r becomes zero (a slight potential difference may occur by the on resistance of the switch sw in practice) by turning on the switch sw when the drive signal Vout is applied to the piezoelectric element 38 according to the dissolved gas content measurement apparatus 30 of the second embodiment, the potential difference between the terminals of the piezoelectric element 38 substantially coincides with the voltage of the drive signal Vout, and it is possible to cause the drive current lout to flow through the piezoelectric element 38 without any loss. In addition, the signal Vi in accordance with the potential difference between the terminals of the resistive element r is obtained by turning off the switch sw after applying the drive signal Vout to the piezoelectric element 38. Therefore, according to the dissolved gas content measurement apparatus 30 of the second embodiment, it is possible to reduce drive loss of the piezoelectric element 38 regardless of the resistance value of the resistive element r, to enhance power consumption efficiency, to increases the resistance value of the resistive element r, and to thereby enhance an S/N ratio of the detection.

### C. Modification Example

The invention is not limited to the above embodiments and can be implemented in various manners without departing from the gist of the invention. The following modifications are applicable, for example.

### C1. Modification Example 1

Although the pressure vibration cycle of the liquid Lq is measured as a behavior of the liquid Lq and the dissolved gas content is obtained in the aforementioned respective embodiments, the invention is not limited thereto, the dissolved gas content may be obtained by various behaviors. For example, the cycle is obtained from a frequency instead of directly obtaining the inherent vibration cycle T. In addition, the inherent vibration cycle T may be obtained by measuring pressure variations in a ¼ cycle or ½ cycle of the pressure vibration and estimating a waveform of the following pressure vibration based on the measurement result. In addition, it is also possible to employ various parameters relating to the liquid Lq, such as the flow amount, the flow rate, and the mobility of the water flowing through the flow path 34, as the behaviors of the liquid Lq. It is possible to achieve the same effect as that in the aforementioned respective embodiments by obtaining the inherent vibration cycle T based on such parameters.

Although the dissolved gas content is measured based on the inherent vibration cycle T of the third wave in the aforementioned respective embodiments, the invention is not limited thereto, and the cycle can be measured based on an arbitrary wave within a range, in which the pressure vibration can be measured, such as the first wave, the second wave, . . . , the tenth wave, . . . . Alternatively, the control unit 52 can measure the respective inherent vibration cycles of the second wave, the third wave, . . . and regard, as the inherent vibration cycle T, a measurement value when an average of the respective inherent vibration cycles or a difference of continuous measurement values is smaller than a threshold value. In doing so, it is possible to reduce an influence of noise and enhance precision in measuring the inherent vibration cycle T.

### C2. Modification Example 2

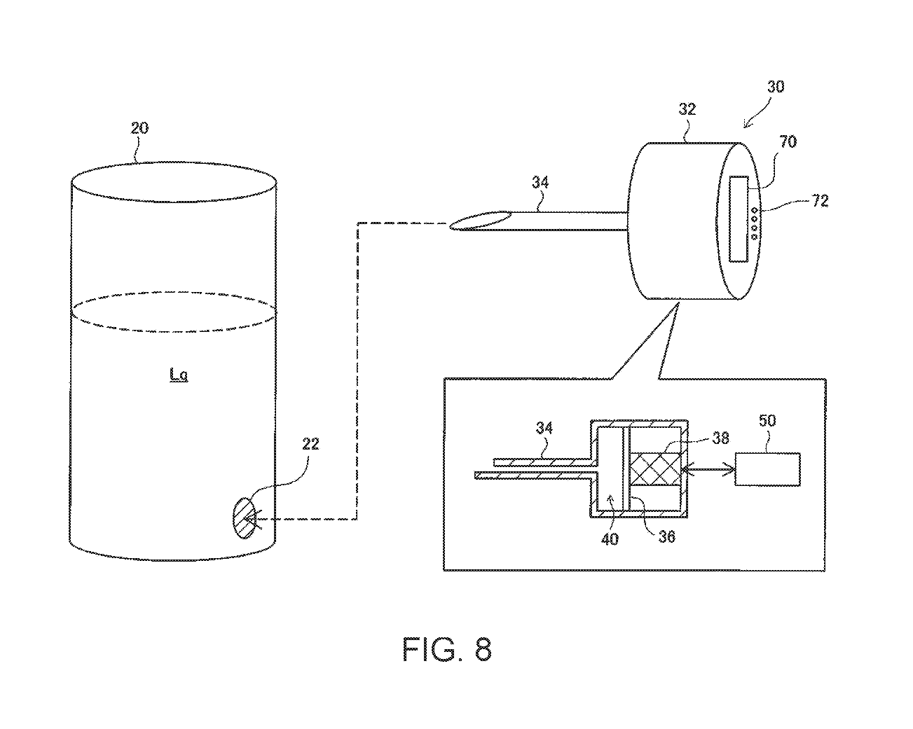

A mode of the dissolved gas content measurement apparatus 30 is not limited to the mode shown in FIG. 1, and various modes can be employed. FIG. 8 is an illustrative diagram showing a mode of a dissolved gas content measurement apparatus according to Modification Example 2. The tip end of the flow path 34 has a sharp shape as shown in the drawing, and the flow path 34 is used by being plunged into the container 20. The container 20 which contains the liquid Lq as a measurement target is provided with an insertion portion 22, into which the flow path 34 is plunged to communicate with the inside of the container 20. The insertion portion 22 is made of a thick rubber member. A hole of the insertion portion 22 formed after pulling out the flow path 34 is blocked by elastic force of the rubber member.

As shown in the drawing, the dissolved gas content measurement apparatus 30 is provided with the display unit 70 and various operation buttons 72 such as a start button for starting the measurement and an operation button for instructing recording of the measurement values. The value of the measured dissolved gas content is displayed on the display unit 70 such that the user can visually recognize the dissolved gas content. By configuring the dissolved gas content measurement apparatus 30 in such a mode, the user can easily measure the dissolved gas content and the compression rate _{K}F of the liquid Lq contained in the container 20. In addition, it is possible to measure the dissolved gas content by directly dipping the flow path 34 into water of river, ocean, or the like without containing the liquid Lq as the measurement target in a container or the like.

### C3. Modification Example 3

Although the piezoelectric element 38 generates the pressure vibration and measures the inner pressure of the pump chamber 40 in the aforementioned respective embodiments, different piezoelectric elements may be used, respectively. That is, the dissolved gas content measurement apparatus 30 may be provided with a piezoelectric element as a pressure difference generating unit and a piezoelectric element as a measurement unit, respectively. Although the piezoelectric element is employed as the pressure difference generating unit in the above embodiments, a magnetostrictor may be used instead of the piezoelectric element. Since the magnetostrictor is greatly displaced due to distortion, it is possible to cause greater pressure vibration. In addition, although the piezoelectric element is employed as the measurement unit in the above embodiments, an ordinary water pressure meter may be employed. With such configuration, it is possible to achieve the same effect as that in the above respective embodiments.

### C4. Modification Example 4

Although the piezoelectric element 38 and the diaphragm 36 are employed as the pressure changing unit in the aforementioned respective embodiments, the invention is not limited thereto, and various configurations capable of changing the pressure in the pump chamber 40 can be employed. For example, the pressure in the pump chamber 40 may be changed by pouring liquid from the outside to the pump chamber 40. With such a configuration, it is possible to achieve the same effect as that in the aforementioned respective embodiments.

### C5. Modification Example 5

Although the resistive element r and the switch sw are connected in parallel between the terminal of the piezoelectric element 38 and the ground and the current flowing through the piezoelectric element 38 is made to flow through the resistive element r when the switch sw is turned off in the second embodiment described above, the resistive element r and the switch sw may be connected in series between the terminal of the piezoelectric element 38 and the ground such that the current flowing through the piezoelectric element 38 is made to flow through the resistive element r when the switch sw is turned on.

### C6. Modified Example 6

Although the pressure vibration is generated by applying the positive-pulse drive signal Vout to the piezoelectric element 38, causing the piezoelectric element 38 to expand, and raising the inner pressure of the pump chamber 40 in the aforementioned respective embodiments, the pressure vibration may be generated by applying a negative-pulse drive signal Vout to the piezoelectric element 38, causing the piezoelectric element 38 to contract, and reducing the inner pressure of the pump chamber 40.

### C7. Modification Example 7

Although the time from the detection of the second pulse of the detection signal DS to the detection of the third pulse is employed as the inherent vibration cycle T in the second embodiment described above, the invention is not limited thereto. The inherent vibration cycle T may correspond to time difference between a peak point (maximum point) of the first wave of the pressure vibration and a peak point (maximum point) of the second wave after elapse of predetermined time after the application of the positive-pulse drive signal Vout to the piezoelectric element 38. With such a configuration, it is possible to achieve the same effect as that in the second embodiment described above.

### C8. Modification Example 8

Although the piezoelectric element 38 and the drive circuit 50 measure the pressure vibration cycle (inherent vibration cycle T) of the liquid Lq and the drive circuit 50 (control unit 52) obtains the dissolved gas content in the liquid Lq based on the pressure vibration cycle of the liquid Lq in the aforementioned respective embodiments, the invention is not limited thereto. The piezoelectric element 38 and the drive circuit 50 may measure a behavior of the liquid within the liquid containing chamber other than the pressure vibration cycle of the liquid Lq, and the drive circuit 50 (control unit 52) may obtain the dissolved gas content in the liquid Lq by using the measurement result. As a tool to analyze the behavior of the liquid other than the pressure vibration cycle of the liquid, it is possible to employ various parameters relating to the liquid, such as a flow amount, a flow rate, and mobility of the liquid.

The aforementioned embodiments and modification examples are described for illustrative purposes, however the invention is not limited thereto. For example, it is also possible to appropriately combine the respective embodiments and the modification examples.

The invention includes substantially the same configurations (for example, configurations with the same functions, methods, and results or configurations for the same purposes and effects) as those described in the embodiments. In addition, the invention also includes configurations, in which non-essential parts of the configurations described in the embodiments are replaced. Moreover, the invention includes configurations which can exhibit the same advantageous effects or configurations which can achieve the same purpose as those described in the embodiment. In addition, the invention includes configurations which are obtained by adding known techniques to the configurations described in the embodiments.

What is claimed is:

1. A dissolved gas content measurement apparatus which measures dissolved gas content in a liquid, comprising:
a flow path which has a flow path resistance;
a liquid containing chamber which communicates with the flow path;
a pressure changing unit which changes inner pressure of the liquid containing chamber;
a measurement unit which measures a pressure vibration cycle of the liquid, which is caused when the pressure changing unit operates, in a state where the liquid is contained in the flow path and the liquid containing chamber; and
an obtaining unit which obtains the dissolved gas content based on the cycle.

2. The dissolved gas content measurement apparatus according to claim 1,
wherein the measurement unit measures the cycle by using a time interval, at which pressure of the pressure vibration in the liquid reaches a predetermined value.

3. The dissolved gas content measurement apparatus according to claim 1,
wherein the measurement unit measures the cycle by using a time interval, at which pressure of the pressure vibration in the liquid reaches a peak.

4. The dissolved gas content measurement apparatus according to claim 1,
wherein the measurement unit measures the cycle by using a time interval, at which pressure of the pressure vibration in the liquid reaches a maximum value.

5. The dissolved gas content measurement apparatus according to claim 1,
wherein the pressure changing unit includes a piezoelectric element and uses the piezoelectric element to change the inner pressure of the liquid containing chamber.

6. The dissolved gas content measurement apparatus according to claim 1,
wherein the pressure changing unit includes a piezoelectric element and uses the piezoelectric element to change the inner pressure of the liquid containing chamber, and
the measurement unit includes a current detecting circuit which detects current flowing through the piezoelectric element, and uses the current detected by the current detecting circuit to measure the cycle.

7. The dissolved gas content measurement apparatus according to claim 1,
wherein the pressure changing unit includes a piezoelectric element and uses the piezoelectric element to change the inner pressure of the liquid containing chamber,
the measurement unit includes a current detecting circuit which detects current flowing through the piezoelectric element, and uses the current detected by the current detecting circuit to measure the cycle, and
the current detecting circuit includes a resistive element and detects the current flowing through the piezoelectric element based on a potential difference between terminals of the resistive element.

8. The dissolved gas content measurement apparatus according to claim 1,
wherein the pressure changing unit includes a piezoelectric element and uses the piezoelectric element to change the inner pressure of the liquid containing chamber,
the measurement unit includes a current detecting circuit which detects current flowing through the piezoelectric element and uses the current detected by the current detecting circuit to measure the cycle,
the current detecting circuit includes a resistive element and detects the current flowing through the piezoelectric element based on a potential difference between terminals of the resistive element, and
the current detecting circuit further includes a switch circuit which is connected to the resistive element in parallel, detects a potential difference which is caused by ON resistance of the switch circuit when the switch circuit is turned on, and detects the potential difference between the terminals of the resistive element when the switch circuit is turned off.

9. The dissolved gas content measurement apparatus according to claim 1,
wherein the pressure changing unit includes a piezoelectric element and uses the piezoelectric element to change the inner pressure of the liquid containing chamber,
the measurement unit includes a current detecting circuit which detects current flowing through the piezoelectric element and uses the current detected by the current detecting circuit to measure the cycle,
the current detecting circuit includes a resistive element and detects the current flowing through the piezoelectric element based on a potential difference between terminals of the resistive element, and
the current detecting circuit further includes a switch circuit which is connected to the resistive element in parallel, detects a potential difference which is caused by ON resistance of the switch circuit when the switch circuit is turned on, detects the potential difference between the terminals of the resistive element when the switch circuit is turned off, and maintains the switch circuit in an ON state when the piezoelectric element is driven.

10. The dissolved gas content measurement apparatus according to claim 1,
wherein the pressure changing unit includes a piezoelectric element and uses the piezoelectric element to change the inner pressure of the liquid containing chamber,
the measurement unit includes a current detecting circuit which detects current flowing through the piezoelectric element and uses the current detected by the current detecting circuit to measure the cycle,
the current detecting circuit includes a resistive element and detects the current flowing through the piezoelectric element based on a potential difference between terminals of the resistive element, and
the current detecting circuit further includes a switch circuit which is connected to the resistive element in parallel, detects a potential difference which is caused by ON resistance of the switch circuit when the switch circuit is turned on, and detects the potential difference between the terminals of the resistive element when the switch circuit is turned off, and brings the switch circuit into an OFF state when the current flowing through the piezoelectric element is detected.

11. The dissolved gas content measurement apparatus according to claim 1,
wherein the pressure changing unit includes a piezoelectric element and uses the piezoelectric element to change the inner pressure of the liquid containing chamber,
the pressure changing unit further includes
a control unit which outputs a drive waveform signal, and
an amplifier circuit which amplifies the drive waveform signal and outputs the drive waveform signal to the piezoelectric element,
the measurement unit includes a current detecting circuit which detects current flowing through the piezoelectric element and uses the current detected by the current detecting circuit to measure the cycle, and
the measurement unit further includes
an integration circuit which integrates the current detected by the current detecting circuit, and
a subtraction circuit which outputs a difference between an output of the integration circuit and the drive waveform signal.

12. The dissolved gas content measurement apparatus according to claim 1,
wherein the liquid is contained in a container,
the liquid containing chamber communicates with one end of the flow path, and
the other end of the flow path is connected to the container.

13. The dissolved gas content measurement apparatus according to claim 1,
wherein the liquid containing chamber communicates with one end of the flow path, and
the other end of the flow path is detachably connected to a container.

14. A liquid treatment apparatus comprising:
the dissolved gas content measurement apparatus according to claim 1.

15. A dissolved gas content measurement apparatus which measures dissolved gas content in a liquid, comprising:
a flow path which includes a flow path resistance;
a liquid containing chamber which communicates with the flow path;
a piezoelectric element; and
a drive circuit which applies a drive signal to the piezoelectric element,
wherein the drive circuit detects current flowing through the piezoelectric element in a state where the liquid is contained in the flow path and the liquid containing chamber, and uses the detected current and a lookup table or a predetermined function to measure the dissolved gas content.

16. A dissolved gas content measurement apparatus which measures dissolved gas content in a liquid, comprising:
a flow path which includes a flow path resistance;
a liquid containing chamber which communicates with the flow path;
a pressure changing unit which changes inner pressure of the liquid containing chamber;
a measurement unit which measures pressure values and time of a plurality of waves in pressure vibration, which are caused when the pressure changing unit operates, in a state where the liquid is contained in the flow path and the liquid containing chamber; and
an obtaining unit which obtains a pressure vibration cycle of the liquid by using a measurement result of the measurement unit and obtains the dissolved gas content.
